(19) United States
(12) Patent Application Publication
(10) Pub. No.: US 2002/0179343 A1
(43) Pub. Date: Dec. 5, 2002

(54) DUAL TRACKED DRIVE UNIT FOR A SELF-PROPELLED IRRIGATION SYSTEM

(76) Inventor: Dennis R. Theilen, Omaha, NE (US)

Correspondence Address: THOMTE, MAZOUR & NIEBERGALL, L.L.C., 2120 S. 72ND STREET, SUITE 1111, OMAHA, NE, 68124, US

(21) Appl. No.: 09/867,361

(22) Filed: May 29, 2001

(51) Int. Cl. B62D 55/00

(52) U.S. Cl. 180/9.21; 180/9.1

(57) ABSTRACT

A drive unit for a center pivot irrigation system is described which has a pair of track units mounted thereon. The drive tower includes an elongated base beam having opposite ends. A drive wheel is mounted on each end of the base beam with the drive wheels being driven in conventional fashion. An idler wheel is operatively rotatably mounted on the base beam inwardly of each end thereof adjacent the respective drive wheels. An endless track member extends around each of the drive wheels and the idler wheel associated therewith. Means is provided for vertical movement of the idler wheels as well as means for yieldably urging the idler wheels downwardly with respect to the base beam.

### BACKGROUND OF THE INVENTION

1. Field of the Invention

This invention relates to a drive unit for a self-propelled irrigation system such as a center pivot or linear move irrigation system and more particularly to a track drive unit for those irrigation systems. More particularly, this invention relates to a dual tracked drive unit for self-propelled irrigation systems.

2. Description of the Related Art

Self-propelled systems such as center pivot and linear move systems normally employ a plurality of wheeled drive units or towers which support and propel the irrigation pipe over the area to be irrigated. The wheels of the drive units frequently create deep wheel tracks in the field. Further, in some situations, the drive wheels slip and are unable to propel the irrigation system. In an attempt to solve the problems associated with wheeled drive units, there have been some attempts at providing a drive unit wherein the same is propelled by an endless track much like a tank track or crawler tractor type. One such system is disclosed in U.S. Pat. No. 5,078,326. Other tracked-type systems for drive towers or units for irrigation systems are found in certain of the prior art cited during the prosecution of the above-identified patent. Another type of tracked drive unit for irrigation systems is disclosed in U.S. Pat. No. 6,131,833.

The prior art devices for improving traction and eliminating wheel tracks on center pivot irrigation systems involve track systems that extend over the entire length of the drive unit base beam. The systems of the prior art are generally built with drive trains specifically designed for the track system and use very few standard components, which causes them to be expensive to build. Since center pivot irrigation systems run in a circle, the tracks constantly turn a corner which puts side loads in the tracks, wheels, and bearings, shortening the life of the components. This is especially true on the drive units closest to the pivot point where the turning radius is very small.

### SUMMARY OF THE INVENTION

A drive unit for a center pivot irrigation system is disclosed. More particularly, a dual tracked drive unit is disclosed which overcomes many of the disadvantages of the prior art. The drive unit includes a standard base beam having conventional drive wheels at the opposite ends thereof which are driven in conventional fashion. If desired, the drive wheels could be comprised of specially designed wheels to fit conventional track members. A first suspension arm has one end thereof pivotally connected to the base beam and has a spring associated with its other end which urges the first suspension arm downwardly with respect to the base beam. A freewheeling idler wheel is rotatably mounted on the first suspension arm adjacent the first drive wheel. An endless track member extends around the first drive wheel and the first idler wheel. A second suspension arm is pivotally connected to the base beam at one of its ends and has a spring associated with its other end which urges the second suspension arm downwardly with respect to the base beam. A second idler wheel is rotatably mounted on the second suspension arm adjacent the second drive wheel. A track member extends around the second drive wheel and the second idler wheel. The track members greatly increase the amount of surface area in contact with the ground and allow the wheels to travel over the ground without sinking thereinto and causing a rut.

It is therefore a principal object of the invention to provide an improved drive unit for a center pivot irrigation system.

Still another object of the invention is to provide a dual tracked drive unit for a center pivot irrigation system.

Still another object of the invention is to provide a dual tracked drive unit for a center pivot irrigation system which includes means for urging the track members downwardly into ground engagement, thereby reducing the load carried by the main drive wheels.

Still another object of the invention is to provide a dual tracked drive unit for a center pivot irrigation system which reduces side loads in the tracks, wheels, and bearings, thereby increasing the life of the components.

Still another object of the invention is to provide a dual tracked drive unit for a center pivot irrigation system which is durable in use.

Still another object of the invention is to provide a dual tracked drive unit for a center pivot irrigation system which employs many of the conventional components on the drive unit.

These and other objects will be apparent to those skilled in the art.

### BRIEF DESCRIPTION OF THE DRAWINGS

FIG. 1 is a perspective view of a center pivot irrigation system having the dual tracked drive units of this invention;

FIG. 2 is a side view of the dual tracked drive unit of this invention;

FIG. 3 is a partial side elevational view of the dual tracked drive unit of this invention;

FIG. 4 is a partial end view of the dual tracked drive unit of this invention;

FIG. 5 is a exploded perspective view of one of the track units on one of the drive units of this invention; and

FIG. 6 is a partial end view of a modified form of the invention.

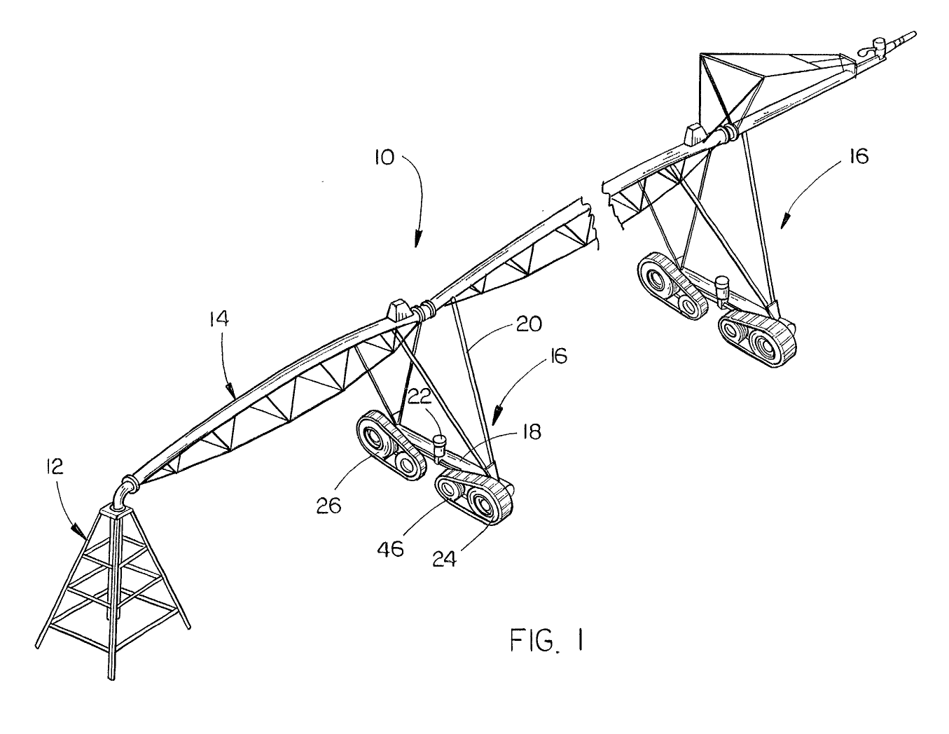

### DESCRIPTION OF THE PREFERRED EMBODIMENT

The numeral 10 refers generally to a center pivot irrigation system including a center pivot structure 12 having a main water conduit 14 extending outwardly therefrom. A plurality of dual tracked drive units 16 support the conduit 14 and propel the same around the center pivot structure 12. Much of each of the drive units 16 is conventional, as will now be described. Drive unit 16 includes a conventional base beam 18 having struts 20 extending upwardly therefrom for connection to the conduit 14. A conventional drive motor 22 is provided on the base beam 18 and is operatively connected to the drive wheels 24 and 26 which are rotatably mounted on the opposite ends of the base beam 18. The conventional drive unit structure is converted to a dual tracked drive unit, as will now be described. For purposes of description, the dual track assemblies on each of the base beams 18 will be identified by the reference numerals 28 and 30, respectively.

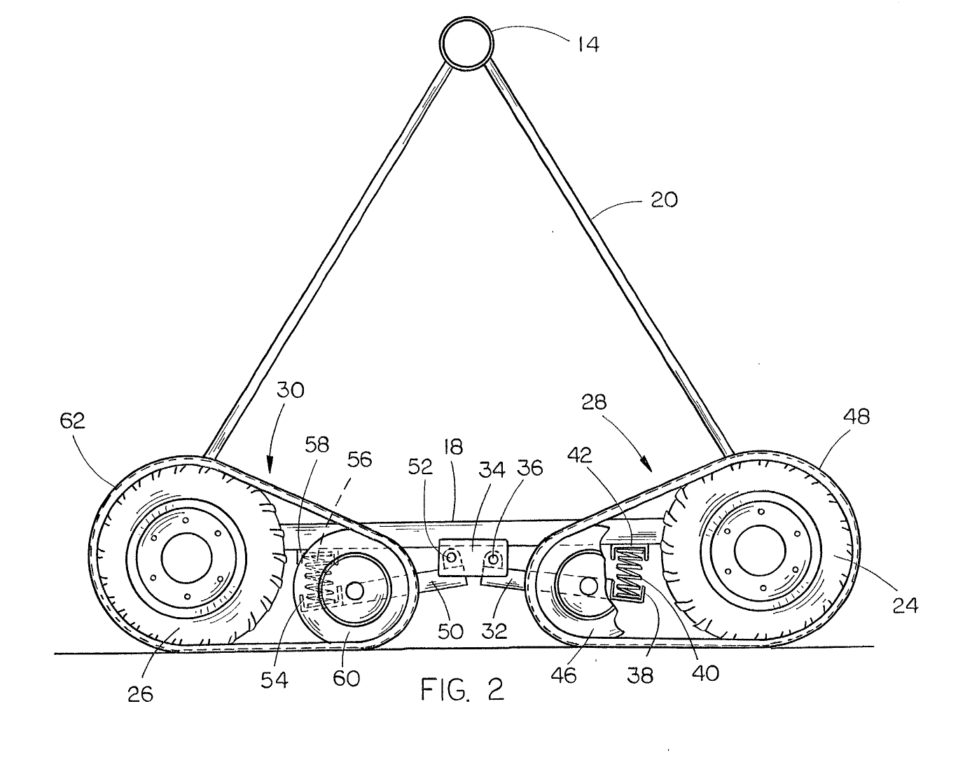

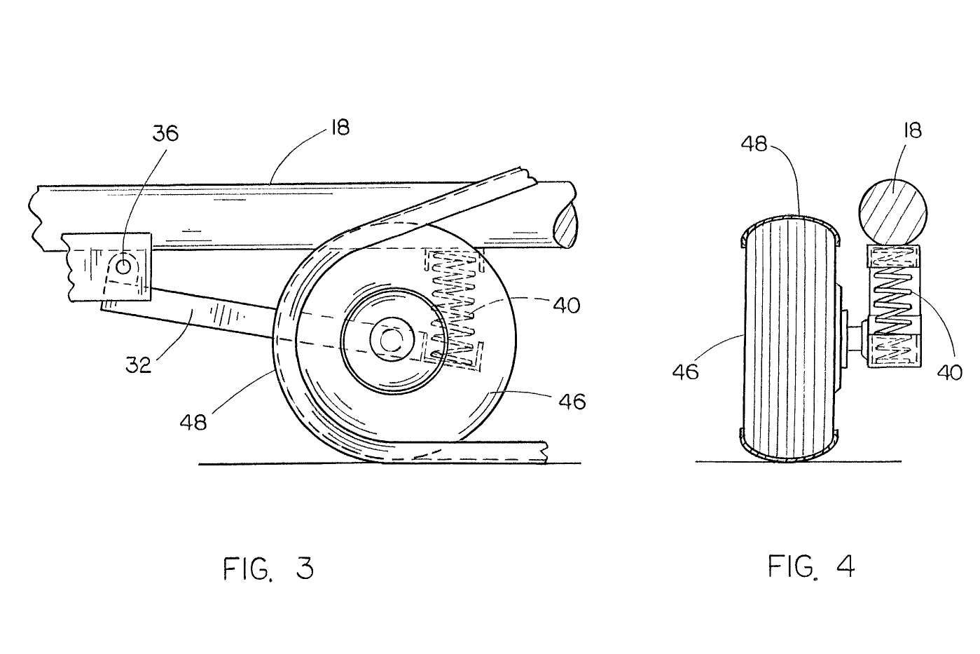

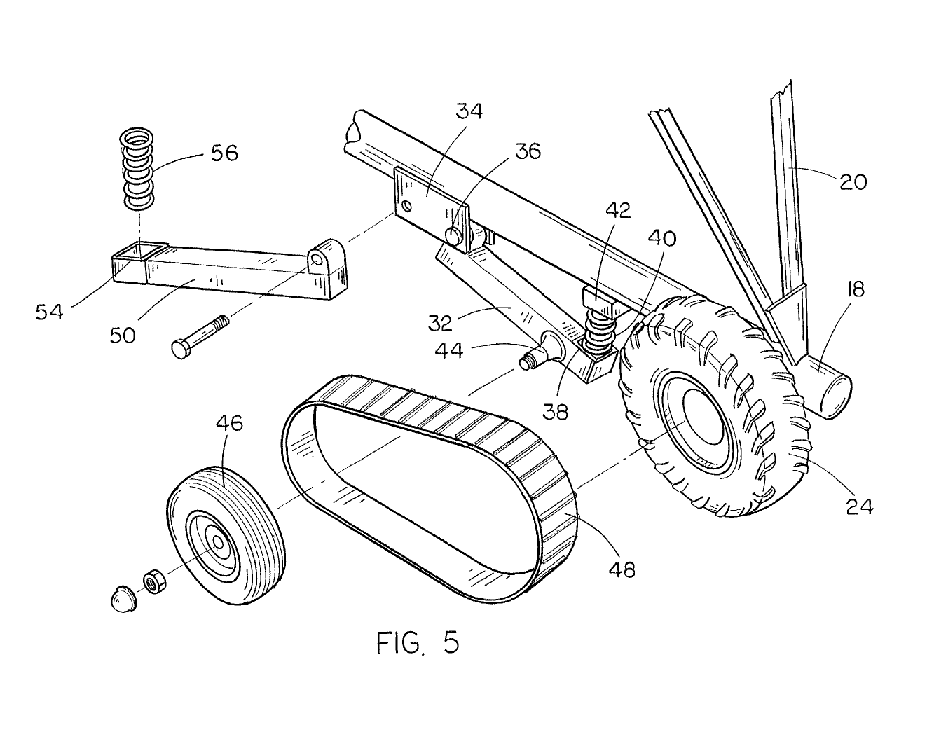

Track unit 28 includes a first suspension arm 32 which has its inner end pivotally connected to bracket 34 at 36. Bracket 34 is secured to base beam 18 by welding or the like. The outer end of suspension arm 32 is provided with a box-like opening 38 which receives one end of a compression spring 40. The upper end of compression spring 40 is received by a box-like member 42 which is secured to base beam 18. Compression spring 40 resiliently urges the outer end of the suspension arm 32 downwardly with respect to base beam 18. Although a compression spring 40 is disclosed, other types of resilient means could also be provided such as shock absorbers, gas springs, bladders, etc. Hub 44 extends outwardly from suspension arm 32 and has a pneumatic idler wheel 46 freely rotatably mounted thereon. An endless track member 48 extends around the pneumatic or non-pneumatic idler wheel 46 and the pneumatic drive wheel 24, as illustrated in FIG. 2. Preferably, the track member 48 has a cross-sectional configuration, such as that seen in FIG. 4, so that it conforms to the outer perimeter of the drive wheel 24 and the idler wheel 46. Although it is preferred that the existing drive wheel 24 be utilized, the drive wheel 24 could be replaced by another type of conventional drive wheel from a conventional track unit, if desired. In that case, idler wheel 46 would also be the type of idler wheel used in conventional track units.

Inasmuch as track unit 30 is identical to track unit 28, the description thereof will be somewhat less detailed. Suspension arm 50 is pivotally connected to bracket 34 at 52 and has a box-like opening 54 at its outer end which receives the lower end of a compression spring 56. The upper end of the compression spring 56 is received in the box-like member 58 which is secured to the under of base beam 18. Idler wheel 60 is rotatably mounted on the suspension arm 50, as seen in FIG. 2. Endless track member 62 extends around idler wheel 60 and drive wheel 26, as also seen in FIG. 2.

The track members 48 and 62 greatly increase the amount of surface area in contact with the ground and allow the tires or wheels to travel over the ground without sinking thereinto and causing a rut. The fact that two separate short tracks are utilized per drive unit instead of one long unit allows alignment to the circular path they must follow. The dual tracked drive unit of this invention provides two additional wheels per drive unit to carry some of the weight. The use of two continuous belts or tracks per drive unit distributes the weight of the drive unit over a larger area of ground than normal in order to increase floatation. Inasmuch as the dual tracked drive unit of this invention utilizes many standard components, it is less expensive to fabricate the unit of this invention. Further, the design of the dual tracked drive unit of this invention enables existing drive units to be easily modified so as to have the dual tracks of this invention.

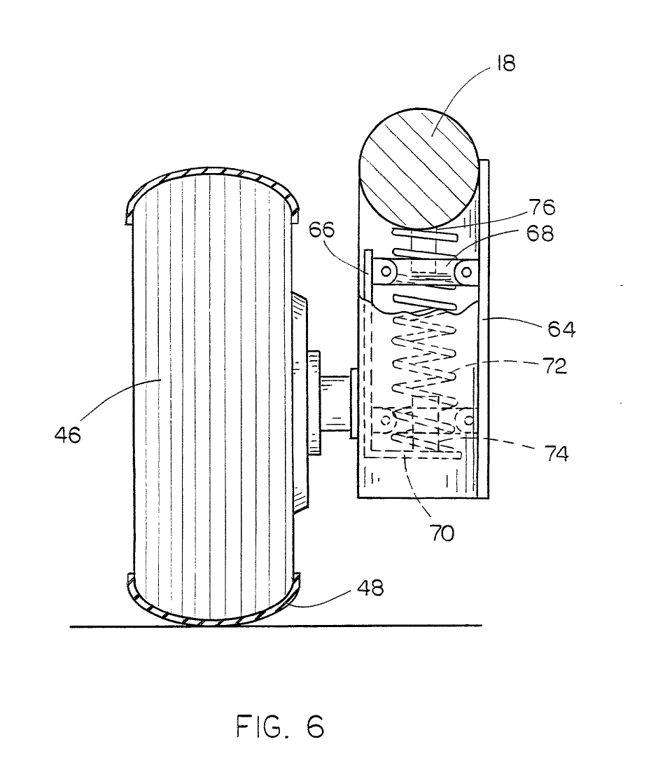

Although the suspension arm means of mounting the idler wheels as described hereinabove is preferred, FIG. 6 illustrates a modified form supporting an idler wheel. As seen in FIG. 6, a plate 64 is secured to base beam 18 and extends downwardly therefrom. Plate 66 is pivotally connected to plate 64 by means of a parallel arm structure referred to generally by the reference numeral 68 so that plate 66 is free to travel upwardly and downwardly with respect to plate 64 while remaining parallel thereto. The lower end of plate 66 has a flange 70 provided thereon which extends toward plate 64 and which supports the lower end of a compression spring 72. As seen in FIG. 6, a support 74 extends upwardly from flange 70 and is received within the interior of the compression spring 72. Similarly, a support 76 extends downwardly from beam 18 and is received within the upper end of the compression spring 72. Compression spring 72 urges the idler wheel 46 downwardly so that the track member 42 is urged into ground engagement.

Thus it can be seen that the invention accomplishes at least all of its stated objectives.

I claim:

1. A drive tower for a self-propelled irrigation system, comprising:
an elongated, generally horizontally disposed base beam having opposite ends;
a first drive wheel rotatably mounted on one end of the said base beam;
a second drive wheel rotatably mounted on the other end of said base beam;
drive means for driving said first and second drive wheels;
a first suspension arm, having first and second ends;
said first end of said first suspension arm being pivotally secured to said base beam;
a first resilient means positioned between said second end of said first suspension arm and said base beam for resiliently urging said second end of said first suspension arm away from said base beam;
a first idler wheel rotatably mounted on said first suspension arm;
a first endless track member extending around said first drive wheel and said first idler wheel;
a second suspension arm, having first and second ends;
said first end of said second suspension arm being pivotally secured to said base beam;
a second resilient means positioned between said second end of said second suspension arm and said base beam for resiliently urging said second end of said second suspension arm away from said base beam;
a second idler wheel rotatably mounted on said second suspension arm;
and a second endless track member extending around said second drive wheel and said second idler wheel.

2. The drive tower of claim 1 wherein said first and second resilient means each comprises a coil spring.

3. A drive tower for a self-propelled irrigation system, comprising:
an elongated, generally horizontally disposed base beam having opposite ends;
a first drive wheel rotatably mounted on one end of the said base beam;
a second drive wheel rotatably mounted on the other end of said base beam;
drive means for driving said first and second drive wheels;
a first idler wheel operatively rotatably and vertically movably mounted on said base beam adjacent said first drive wheel;
a first resilient means associated with said first idler wheel for yieldably urging said first idler wheel downwardly with respect to said base beam;
a first endless track member extending around said first drive wheel and said first idler wheel;
a second idler wheel operatively rotatably and vertically movably mounted on said base beam adjacent said second drive wheel;
a second resilient means associated with said second idler wheel for yieldably urging said second idler wheel downwardly with respect to said base beam;
and a second endless track member extending around said second drive wheel and said second idler wheel.

4. A drive tower for a self-propelled irrigation system, comprising:
an elongated, generally horizontally disposed base beam having opposite ends;
a first drive wheel rotatably mounted on one end of the said base beam;
a second drive wheel rotatably mounted on the other end of said base beam;
drive means for driving said first and second drive wheels;
a first rotatable idler wheel operatively supported by said base beam adjacent said first drive wheel;
a first endless track member extending around said first drive wheel and said first idler wheel;
a second rotatable wheel operatively supported by said base beam adjacent said second drive wheel;
and a second endless track member extending around said second drive wheel and said second idler wheel.

5. The drive tower of claim 4 wherein resilient means is associated with each of said first and second idler wheels for yieldably urging said first and second idler wheels downwardly with respect to said base beam.

6. The drive tower of claim 4 wherein the diameters of said first and second idler wheels are less than the diameters of said first and second drive wheels.

7. The drive tower of claim 4 wherein said first and second drive wheels are pneumatic tires.

8. The drive tower of claim 7 wherein said first and second idler wheels are pneumatic tires.

9. The drive tower of claim 8 wherein said endless track members have a cross-sectional configuration so as to conform to the peripheral shape of said drive wheels and said idler wheels.

10. The drive tower of claim 7 wherein said first and second idler wheels are non-pneumatic tires.
